(19) United States
(12) Patent Application Publication
(10) Pub. No.: US 2008/0116660 A1
(43) Pub. Date: May 22, 2008

(54) Elastomeric Wheelchair Suspension

(76) Inventor: Kevin Nicholls, Ontario (CA)

Correspondence Address: FAY SHARPE LLP, 1100 SUPERIOR AVENUE, SEVENTH FLOOR, CLEVELAND, OH, 44114, US

(21) Appl. No.: 11/795,702

(22) PCT Filed: Jan. 19, 2006
(86) PCT No.: PCT/US06/01817

§ 371 Date: Sep. 18, 2007

Related U.S. Application Data
(60) Provisional application No. 60/645,396, filed on Jan. 19, 2005.
(60) Provisional application No. 60/645,270, filed on Jan. 19, 2005.

(51) Int. Cl. A61G 5/10; B60B 33/00

(52) U.S. Cl. 280/286; 280/86.1

(57) ABSTRACT

A suspension system (12, 112, 212, 312, 412) suited to use in a wheelchair (10) or other transportation system includes a first member (30, 130, 230, 330, 430) and a second member (32, 132, 232, 332, 432), which is pivotable relative to the first member. One of the first and second members includes a socket (42, 142, 242, 342) in which a bushing (60, 160, 260, 360) is mounted which receives a rigid member, such as a shaft (150, 250, 350) and or insert (55, 155, 255, 355) therein, the rigid member being coupled to the other of the first and second members. The bushing develops a resistance force as the second member pivots relative to the first1 structural member. The resistance force resists further pivoting of the second structural member relative to the first member.

### BACKGROUND OF THE INVENTION

The present exemplary embodiment relates to the field of shock absorption. It finds particular application in connection with a suspension system for improving the ride of a wheelchair over rough or uneven surfaces, and will be described with reference thereto. However, it will be appreciated that the invention finds application in other suspension systems.

Wheelchairs commonly encounter uneven terrain during movement and often include components designed to absorb the input vibrations and energy from surface irregularities that directly affect wheelchair comfort and durability. Typically, however, the small front wheels or casters of a wheelchair are mounted into a rigid fork assembly, transmitting all vibrations and road inputs directly to the frame of the wheelchair. While attention has focused on reducing the impact forces transferred through the rear wheels, several wheelchair designs have included suspension systems associated with the casters for absorption of forces perpendicular to the travel surface. One such suspension system includes a hinged assembly with a urethane bumper. While the bumper allows a measure of compliance in the vertical direction for gross surface variations, higher-frequency inputs in all directions are transmitted to the frame via the transfer path of the hinge.

The present invention provides a new and improved suspension system and method of use which overcome the above-referenced problems and others.

### BRIEF DESCRIPTION OF THE INVENTION

In accordance with one aspect of the present exemplary embodiment, a suspension system is provided. The suspension system includes a first structural member. A second structural member is pivotable relative to the first structural member. One of the first and second structural members includes a socket. An insert is mounted in the socket, the insert being operably connected with the other of the first and second structural members. A resilient member is mounted in the socket. The resilient member defines a bore which receives the insert. The resilient member develops a resistance force as the second structural member pivots relative to the first structural member, the resistance force resisting further pivoting of the second structural member relative to the first structural member.

In accordance with another aspect of the present exemplary embodiment, a suspension system includes a first structural and a second structural member which carries a wheel, the second structural member being pivotable relative to the first rigid member. A resilient member isolates the second rigid member from the first rigid member such all vibration transfer paths between the first and second structural members pass through the resilient member.

In accordance with another aspect of the present exemplary embodiment, a system of transport is provided. The system includes a frame and a wheel for conveying the transport system across a surface. A suspension system includes a first member, which is pivotally connected to the frame and a second member which carries the wheel. A resilient member is mounted to one of the first and second members, the resilient member defining a bore which receives a rigid member therein, the rigid member being operably connected with the other of the first and second members, the resilient member isolating the second member from the first member In accordance with another aspect of the present exemplary embodiment, a method of absorbing shocks in a suspension system includes pivoting a second structural member relative to a first structural member, the first and second members being spaced by a resilient member which isolates the first member from the second member, the resilient member developing a resistance force as the second member pivots relative to the first member. The resistance force resists further pivoting of the second member relative to the first member.

In another aspect, a method of absorbing shocks in a suspension system includes pivoting a second structural member relative to a first structural member, the first and second members being spaced by a resilient member which isolates the first member from the second member, the resilient member developing a resistance force as the second member pivots relative to the first member the resistance force resisting further pivoting of the second member relative to the first member.

### BRIEF DESCRIPTION OF THE DRAWINGS

FIG. 1 is a perspective view of a wheelchair incorporating a first embodiment of a suspension system;

FIG. 2 is an enlarged perspective view of a first embodiment of the suspension system of FIG. 1;

FIG. 3 is an exploded perspective view of the suspension system of FIG. 2;

FIG. 4 is another exploded perspective view of the suspension system of FIG. 1;

FIG. 5 is an enlarged perspective view of another embodiment of the suspension system of FIG. 1;

FIG. 6 is an exploded perspective view of the suspension system of FIG. 5;

FIG. 7 is an enlarged side view of the first member, insert, and bushing of the suspension system of FIG. 5;

FIG. 8 is a perspective view of an alternative embodiment of the first member, insert, and bushing of the suspension system of FIG. 5;

FIG. 9 is a theoretical plot of the buildup of forces in the bushing of FIGS. 5 and 6 as the insert rotates through an angle;

FIG. 10 is an enlarged exploded perspective view of a third embodiment of the suspension system of FIG. 1;

FIG. 11 is a perspective view, partially cut away, of the suspension system of FIG. 10;

FIG. 12 is a perspective view of a fourth embodiment of the suspension system of FIG. 1;

FIG. 13 is a cross sectional view of the suspension system of FIG. 12;

FIG. 14 is bottom perspective view of the suspension system of FIG. 12; and

FIG. 15 is a perspective view of a fifth embodiment of the suspension system of FIG. 1.

### DETAILED DESCRIPTION OF THE INVENTION

One aspect of the present exemplary embodiment is directed to a suspension system suited to use in wheelchairs and other vehicles. The suspension system includes first and second structural member, the second structural member being pivotable relative to the first structural member. One of the first and second structural members includes a socket. A rigid member is mounted in the socket, the rigid member being operatively connected with the other of the first and second structural members so as to resist movement relative thereto. A resilient member is mounted in the socket, the resilient member defining a bore which receives the rigid member therein. The resilient member develops a resistance force as the second structural member pivots relative to the first structural member, the resistance force resisting further pivoting of the second structural member relative to the first structural member.

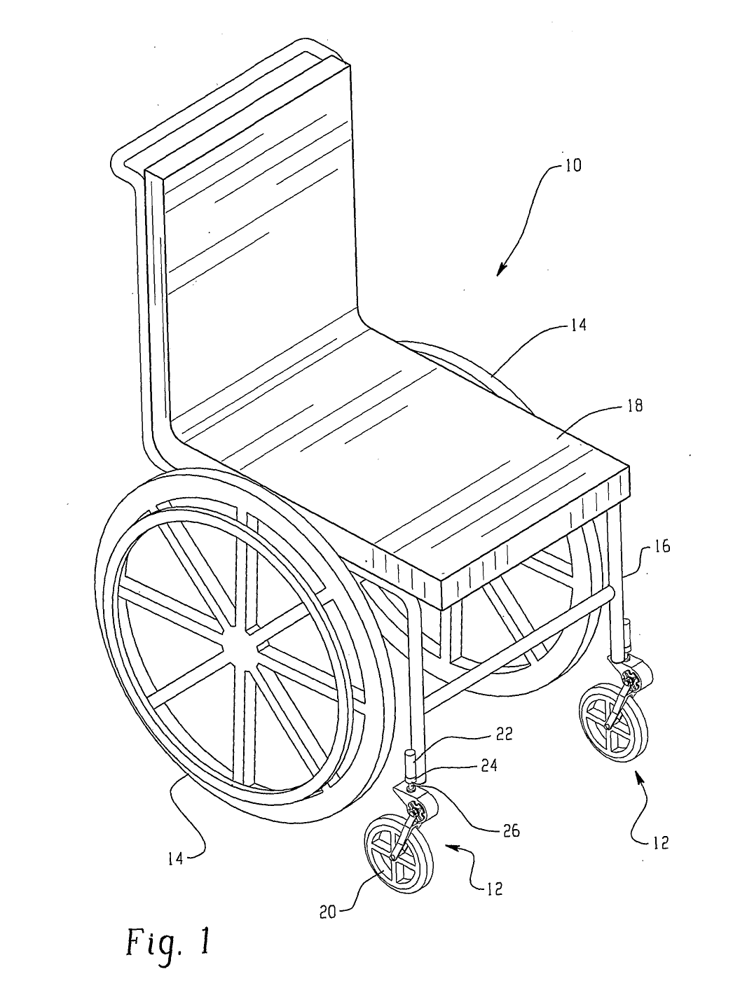

With reference to FIG. 1, a wheelchair 10 including a pair of independent wheel suspension systems 12 is shown. The wheelchair also includes a pair of large rear wheels 14, which may be manually or mechanically driven, a frame 16, and a seat 18 supported by the frame. In FIG. 1, the suspension systems 12 are associated with small front wheels 20 of the wheelchair, although it is also contemplated that the small wheels may be located at the rear of the wheelchair. Each suspension system 12 may be connected to the frame by a swivel connection system 22, which allows the front wheels to swivel, relative to the frame. In the illustrated embodiment, each swivel connection system includes a receiving member 24, such as a mount socket, which is mounted to the frame 16 for coupling with a corresponding vertical connector 26, such as a stembolt, on the respective suspension system 12.

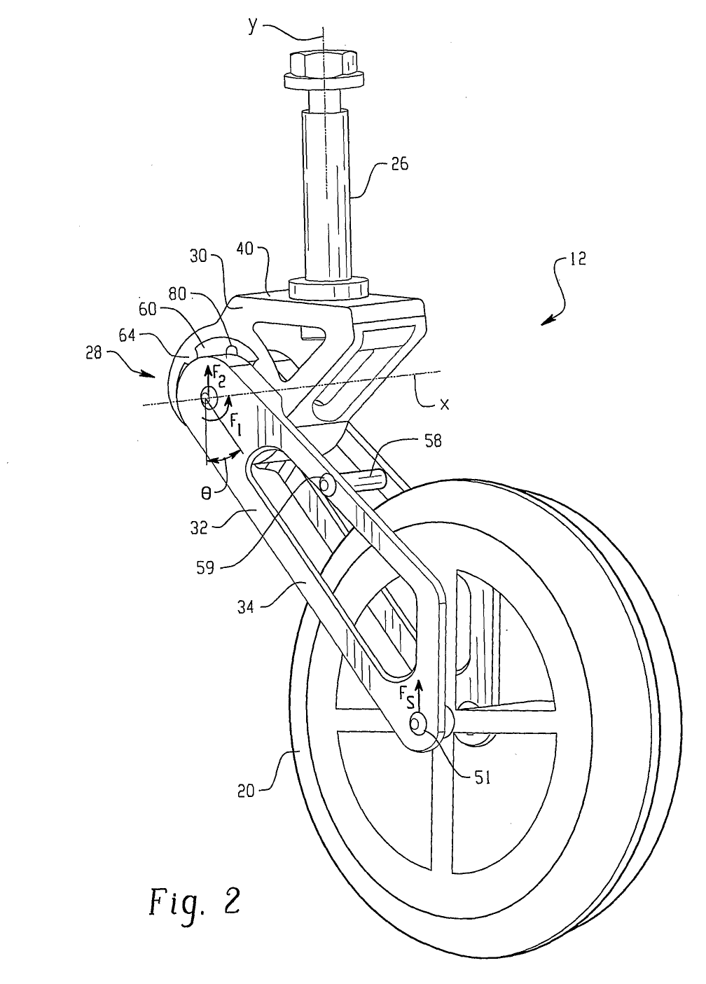

With reference to FIGS. 2-4, a first embodiment of a suspension system 12 according to the present exemplary embodiment is shown. The suspension system 12 includes a first structural member 30 which includes the stembolt 26 and a generally cylindrical member or bracket 31 attached thereto. A second structural member 32 is rotatable, relative to the first structural member. The second structural member 32 includes a supporting member 34, such as a fork or clevis, for receiving a front wheel 20. In normal operation of the wheelchair, the fork 34 is angled downward and rearward, away from the first structural member 30, as shown in FIG. 1. The first and second structural members 30, 32 may be formed from metal, such as aluminum, a composite, or other suitable rigid material. The wheel 20 is rotatably mounted between distal ends of arms 36, 38 of the fork 34 for engaging a floor or other surface over which the wheelchair travels. Alternatively, each arm 36, 38 may support a separate wheel. The stembolt 26 extends generally perpendicularly from an upper surface 40 of the bracket 31. In operation, the surface 40 is aligned generally parallel with the floor surface.

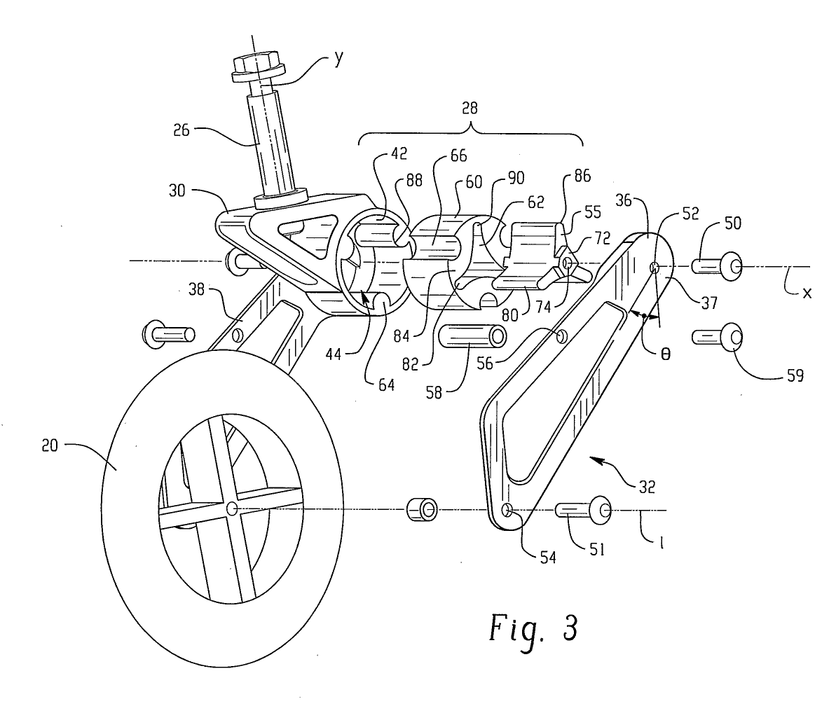

The cylindrical member 31 defines a generally cylindrical socket 42 which extends through the bracket and has first and second open ends 44 (FIG. 3). A longitudinal axis x of the socket is perpendicular to a longitudinal axis y of the stembolt and, in the illustrated embodiment, is forwardly spaced from the stembolt axis y. The arms 36, 38 of FIGS. 2-4 are in the form of generally triangular plates which space the wheel axis l from the axis x. The angle θ between perpendicular and the arms 36, 38 of the second member 32 is less than 90° and in one embodiment is about 45°, or less. However, it is also contemplated that the stembolt 26 and second member may be oriented generally parallel to one another, absent an applied force, and may be collinear.

As shown in FIG. 3, elongated connecting members 50, 51, such as screws, bolts, rivets, or the like, are mounted through respective bores 52, 54 at ends of the clevis arms 36, 38. Specifically, rivet 51 attaches the arms 36, 38 to the axis of the wheel 20 for rotatable movement of the wheel relative to the arms. Connecting members 50 lock the arms 36, 38 to a rigid insert 55, as will be described in greater detail below, at an end 57 of the arm, remote from the wheel 20. The insert 55 a rigid member which serves as a pivot axis by which the second member is pivotable relative to the bracket 30 about an axis of rotation which is aligned with or generally parallel to axis x. The rigid member 55 is constrained against movement relative to the second member.

Optionally, a third bore 56 in each arm 36, 38 is used to connect the arms to a connecting member 58 (FIG. 2) by means of rivets or other suitable attachment members 59, at a location intermediate the wheel 20 and bore 52, to provide additional rigidity to the clevis 34.

A resilient member 60 in the form of a unitary molded bushing is mounted in the socket 42. The bushing 60 is generally in the shape of an annulus which defines an axial bushing bore 62 at least partially therethrough that receives the insert 55 therein. The bushing 60 is configured to develop a resistance force as the second member 32 pivots relative to the first member 30 about the insert 55. The resistance force resists further pivoting of the second member 32 relative to the first member 30. The bushing 60 may be formed from an elastomeric material, such as a natural or synthetic rubber, urethane, or other suitable compliant polymer. The cross section of the bushing 60 may be larger than that of the aperture 42 such that the bushing is compressed when positioned in the aperture. Depending on the usage of the wheelchair, the stiffness and damping characteristics of the bushing 60 may be selected to meet the needs of the user.

As illustrated in FIG. 3, the bracket 30 includes one or more arcuately spaced projections 64 which extend into the socket 42. Three radially spaced projections 64, which extend along the length of the socket 42, are shown in the illustrated embodiment, although it is also contemplated that fewer or more than three projections may be employed, such as two, four, five, or six projections. It is also contemplated that the projections be unequally spaced. The bushing 60 has complementary exterior recesses 66 shaped to receive the projections therein. The projections 64 may be integrally formed with the bracket and are thus are rigid. Or, the projections 64 may be welded or otherwise rigidly connected to the bracket 30, and thus may be formed from a different material. In either case, the projections are formed from a material which has a greater rigidity than that of the bushing. The projections 64 assist in prevent the bushing 60 from rotating in the socket 42. The projections 64 also serve as hard stops or travel restrictors, as will be described in greater detail below.

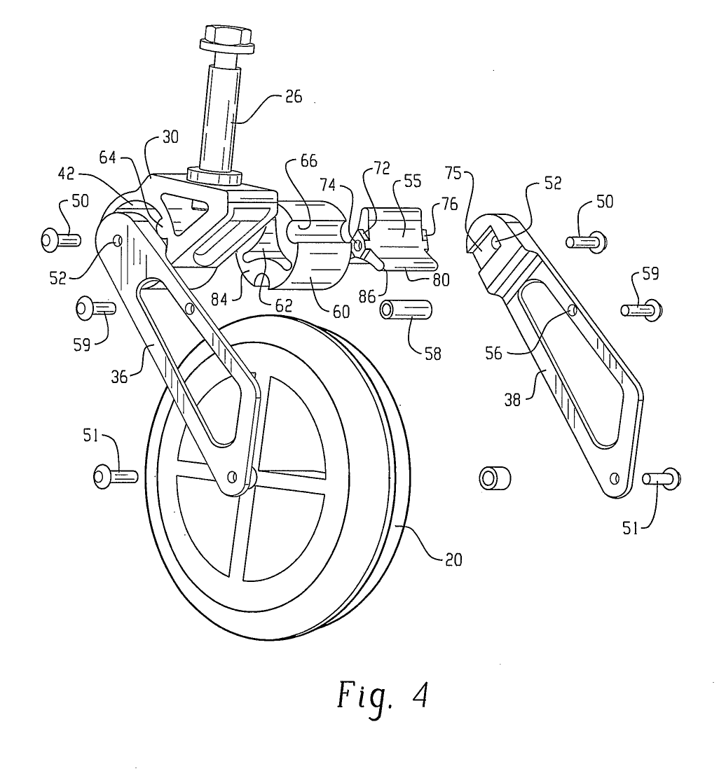

The removable insert 55 is received within the bushing bore 62 of the bushing 60 and includes an inner portion 72 which defines an axial bore 74 shaped to receive the connecting members 50 therein. The insert 55 is formed from a rigid material, such as that used for forming the bracket 30. The insert 55 is configured to limit or eliminate relative movement between the insert and the arms 36, 38. As illustrated in FIG. 4, the arms 36, 38 include key slots 75 shaped to receive complementary shaped keying members 76 at opposed ends of the insert inner portion 72. In the illustrated embodiment, the keying members 76 stand proud of the bushing, when assembled, and are generally rectangular, although other shapes having angles, projections, or other eccentricities are also contemplated. The keying members slidably engage a corresponding rectangular slot 75 until the apertures 52 and bore 74 are in alignment. In this position, the insert is attached to the arms by the connecting members 50. Other arrangements which key or otherwise lock the insert 55 to the arms 36, 38 and thus constrain the insert against movement relative to the second member are also contemplated. Together, the insert 55, bushing 60, and first member 30 comprise the torsion control system 28 of the suspension system 12.

With reference to FIG. 4, the insert 55 includes one or more exterior spokes 80 which extend radially outward from the central portion 72 and which may be integrally formed therewith. The bushing bore 62 defines complementary pockets 82 (FIG. 3) which snugly receives the respective spokes 80 therein. Three radially spaced spokes 80 are shown in the illustrated embodiment, although it is also contemplated that fewer or more than three spokes may be employed, such as one, two, four, five, or six spokes. It is also contemplated that the spokes be unequally spaced. In one embodiment, the three spokes 80 are equally spaced, angularly, each spoke being equidistant from each of a pair of the projections 64. The spokes and projections can be interdigitated, with one spoke between each pair of projections. The illustrated spokes are rounded at their tips and of generally uniform width, although other shapes are contemplated. In the illustrated embodiment, the three projections 64 are spaced at 120° apart with one of the projections being aligned generally parallel with the y axis and one of the spokes 80 being aligned generally parallel with the y axis, the other two spokes angled at 60° to the y axis, although other orientations are also contemplated.

The spokes 80 are radially spaced from the adjacent projection(s) 64 by an adjacent interior portion 84 of the bushing (FIG. 3). In the illustrated embodiment, tips 86 of the spokes are located radially outward of tips 88 of the projections such that, absent the bushing 60, the spokes 80 are able to contact the adjacent projections 64 when the insert 55 is rotated relative to the first member 30. However, it is also contemplated that the tips 86 may be located radially inward of the projections 64. The tips 86 of the spokes are spaced from the bracket 30 by a peripheral portion or wall 90 of the bushing. Thus, all forces which are transmitted to the insert 55 from the arms 36, 38 (FIG. 2 illustrates a radial resistance force F₁ and axial force F₂, by way of example) are isolated from the frame by the bushing 60 and are at least partially absorbed by the complementary damping forces generated in the bushing. Thus, all vibrations and other forces which would otherwise be transferred to the frame 16 of the wheelchair from the second member 32 pass through and are at least partially absorbed by the bushing 60. The illustrated bushing 60 acts as an interface between the first and second members for all vibration forces generated in the second member, irrespective of the direction of the force. In normal operation of the wheelchair, contact between the rigid insert and the rigid bracket is prevented by the bushing since the insert is spaced from the bracket in all directions and there are no other sources of metal to metal (or other rigid material) contact between the first and second members. The suspension system is thus free of non-isolated transfer paths which could otherwise transfer vibrations and other road inputs directly to the frame of the wheelchair.

When the front wheel 20 of the wheelchair experiences a large amplitude input, such as a bump or depression in the floor surface, the wheel is displaced in a direction generally parallel with y axis, as illustrated by arrows F_{S} (FIG. 2). This creates a rotational force F₁ on the insert 55, which begins to rotate, relative to the bushing 60. Complementary radial resistance forces develop in the bushing, which resist rotation.

In the absence of projections 64, the compressive rate build up in the bushing 60 is a relatively linear one, resembling a shear curve with minimal or no rate build-up. However, the projections 64 on the bracket 30 serve as travel restrictors for providing travel control by creating a resistance force which increases rapidly as the spoke 80 approaches the adjacent projection 64. The travel restrictors thus limit the extent of rotation of the insert and the shaft and thus limit the extent of vertical travel in the front wheel 20. This prevents the front of wheelchair frame 16 from diving (tipping up or down) unduly. The projections 64 and spokes 80, in cooperation with the elastomeric material of the bushing 60 therebetween, thus serve a similar function to a hard stop, without creating the jarring which a conventional hard stop provides. It will be appreciated that the greater the number of projections 64 and spokes 80, the shorter the extent of vertical travel of the wheel which will be permitted. The hard stops are tunable, in the sense that fewer or more projections 64 can be employed to allow for gross motion control without relying solely on the integrity of the elastomer of the bushing. Additionally, changing the size of the rigid parts, such as the spokes or projections, also influences the extent of travel. For example, increasing the wall thickness of the spokes decreases the extent of travel.

To assemble the torsion control system 28, the insert 55 may be inserted into the bushing bore 62. Or the material for forming the bushing (such as a latex rubber material) may be molded on to the insert and set in place, thereby forming the bushing 60 and its bushing bore 62. The assembled bushing and insert are then squeezed into the socket 42, with the recesses in the bushing matching up with the projections. Alternatively, the insert 55 is inserted into the bushing bore 62 after positioning the bushing in the socket. As another alternative, the insert, bushing and socket can be molded as an assembly. The insert ends are then slid into the respective slots 75 and arms 36, 38 are connected to the insert and to each other and the wheel, with the connection members 50, 51, 59.

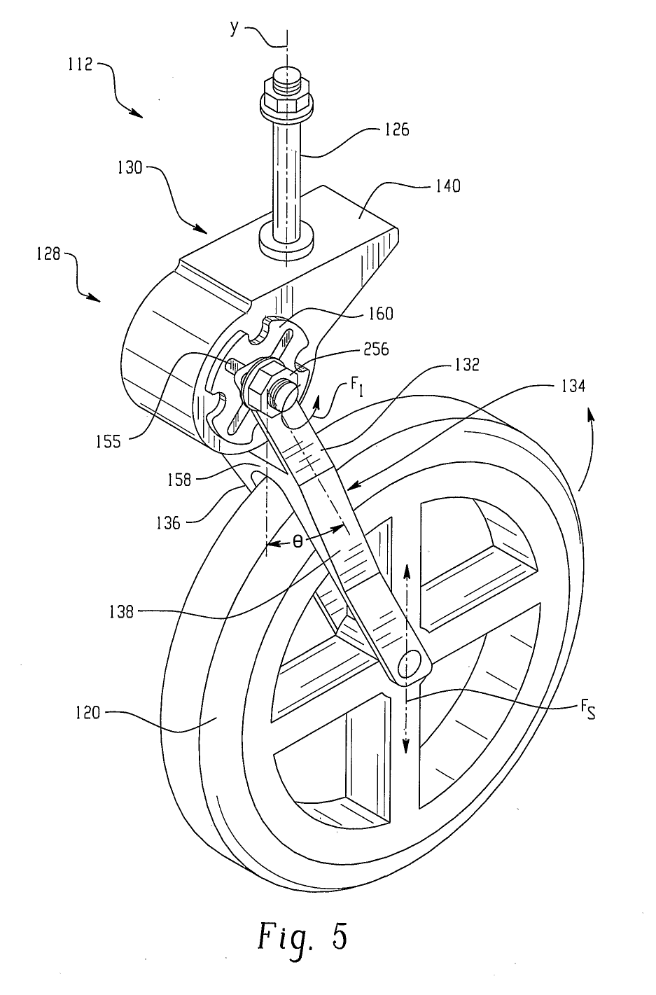

With reference to FIGS. 5-7, a second embodiment of a suspension system 112 for the wheel chair of FIG. 1 is shown. Similar elements are accorded similar numerals, raised by 100. The suspension system 112 is similar to the suspension system 12, except as otherwise noted and includes a torsion control system 128 comprising a first structural member 130, in the form of a mounting bracket, a rigid member comprising an insert 155, and a bushing 160. A second structural member 132, which includes a fork or clevis 134, receives a front wheel 120. The wheel 120 is rotatably mounted between distal ends of arms 136, 138 of the fork 134 for engaging a floor or other surface over which the wheelchair travels. In this embodiment, the clevis can be molded as a unitary member. A stembolt 126 extends generally perpendicularly from an upper surface 140 of the bracket 130.

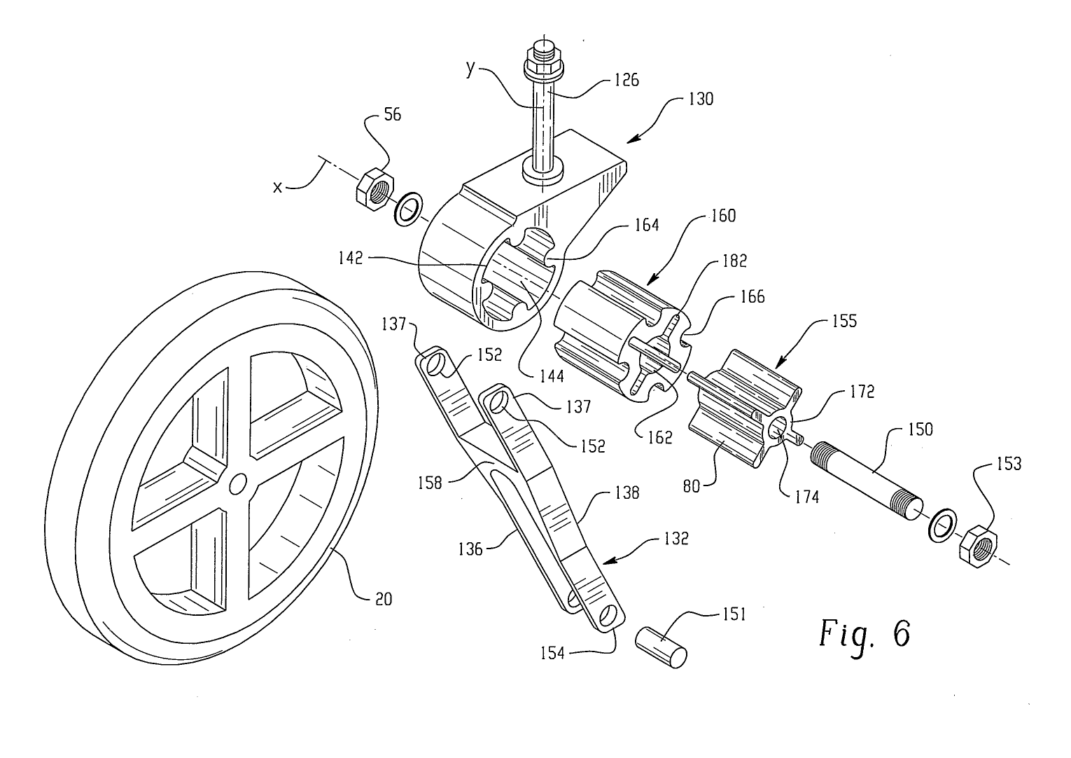

The bracket 130 defines a generally cylindrical socket 142 which extends through the bracket and has first and second open ends 144 (FIG. 6).

As shown in FIG. 3, the rigid member further includes a shaft 150, such as a threaded stud, which is mounted through respective bores 152 at ends 137 of the fork arms 36, 38 remote from the wheel 120. The shaft 150 is locked in place to the arms by suitable threaded lock nuts 153 or other fixing members, which engage threaded ends of the shaft 150 and constrain the shaft against movement relative to the second member 132. Intermediate the fork arms 136, 138, the shaft 150 passes through the socket 142. The shaft 150 serves as a pivot axis by which the second member 132 is pivotable relative to the bracket 130 about an axis of rotation which is aligned with or generally parallel to x axis. The insert 155 is locked against movement relative to the second structural member 132 by the shaft 150.

Optionally, a connecting member 158 (FIG. 6) connects the fork arms 136, 138 intermediate the wheel 120 and bores 152 to provide additional rigidity to the fork 134. The connecting member 158 may be integrally formed with the arms 36, 38 or a separate element, as for member 58.

The bushing defines a bore 162 which receives the insert 155 therein and the shaft 150 of the second member 132 therethrough.

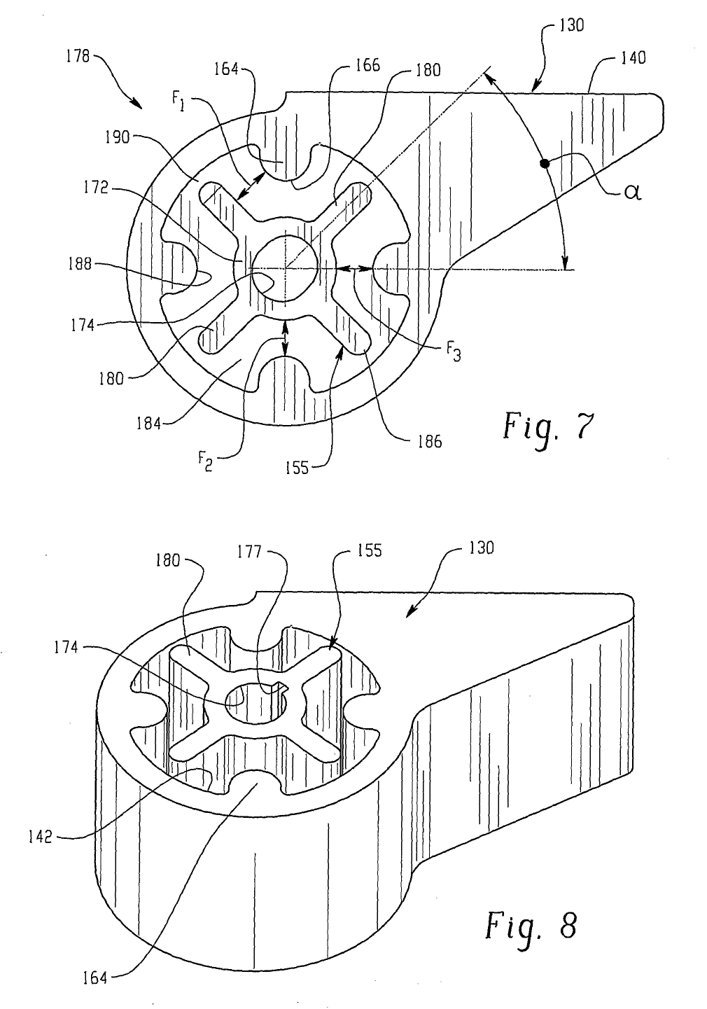

As illustrated in FIG. 6, the bracket 130 includes four radially spaced projections 164 which extend into the socket 142 although fewer or more than four projections may be employed. The bushing 160 has four complementary exterior recesses 166 shaped to receive the projections therein. The removable insert 155 is received within the bushing bore 162 of the bushing 160 and includes a generally cylindrical inner portion 172 which defines an axial bore 174 shaped to receive the shaft 150 therethrough. In this embodiment, the insert bore 174 is configured to limit or eliminate relative movement of the shaft 150. In the embodiment illustrated in FIG. 7, the insert bore 174 is eccentric, e.g., oval or elliptical in shape, and receives a complementary oval or elliptical portion of the shaft 150. Other arrangements which key the shaft 150 to the bushing bore and thus constrain the shaft against movement relative to the insert are also contemplated. For example, as shown in FIG. 8 (which shows the bushing removed for clarity), the bore (or the shaft) may include at least one keyhole slot 177 which receives a complementary keyed projection (not shown) on the shaft 150 (or bore). In one embodiment, the insert 155 is slightly longer in axial length than the bushing 160 such that the installed insert is proud of the bushing.

Alternatively, the shaft 150 and insert 155 may be integrally formed, e.g., with the cylindrical inner member 172 being defined by a mid portion of the shaft 150. In yet another embodiment, the shaft 150 is welded or otherwise rigidly attached to the insert 155.

It will be appreciated that the insert 155 with the elliptical or keyed insert bore 174 may alternatively be employed with a pair of complementary connecting members similar to connecting members 50 to attach the torsion control system 128 to a second structural member similar to member 32 for a positive interlock. In such an embodiment, the keying members 76 and complementary slots 75 can be eliminated.

With reference to FIG. 7, the insert 155 includes four exterior spokes 180 which extend radially outward from the central member 72 and are received in complementary pockets 182 (FIG. 6) in the bushing aperture, although it is also contemplated that fewer or more than four spokes may be employed. In the illustrated embodiment, the four projections 164 are spaced at 90° apart with two of the projections being aligned generally parallel with the y axis and the spokes 180 angled at 45° to the y axis, although other orientations are also contemplated.

The spokes 180 are radially spaced from the adjacent projection(s) 164 by an adjacent interior portion 184 of the bushing. Tips 186 of the spokes 180 are located radially outward of tips 188 of the projections such that, absent the bushing 160, the spokes 180 are able to contact the adjacent projections 164 when the insert 155 is rotated relative to the first member 130. However, it is also contemplated that the tips 186 may be located radially inward of the projections 164. The tips 186 of the spokes 180 are spaced from the bracket by a peripheral portion or wall 190 of the bushing. Thus, all forces which are transmitted to the insert 155 from the arms 136, 138 and shaft 150 (FIG. 5 illustrates a radial resistance force F₁ and axial forces F₂ and F₃, by way of example) are isolated from the frame by the bushing 160 and are at least partially absorbed by the complementary damping forces generated in the bushing. Thus, all vibrations and other forces, which would otherwise be transferred to the frame 16 of the wheelchair from the second member 132, pass through and are at least partially absorbed by the bushing 160, as discussed for the embodiment of FIGS. 2-4.

The torsion control system 128 can be assembled in a similar manner to system 28, except in that shaft 150 passes all the way through the bore 180 and is clamped to the arms 138 by threaded engagement of the ends of the shaft with the lock nuts 153.

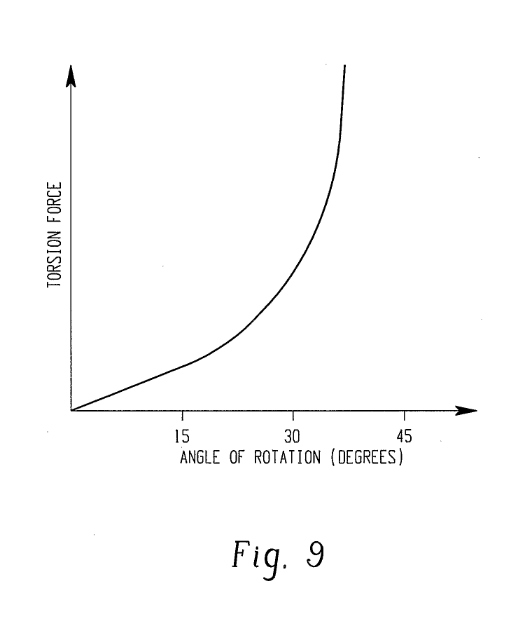

FIG. 9 shows a theoretical plot of the buildup of forces in the bushing 160 as the insert 155 rotates for the suspension system of FIGS. 5 and 6, i.e., with four projections and four spokes. A similar buildup is obtained for the system of FIGS. 2-4, although with larger angles, due to the increased spacing between the spokes. Initially, the rate build up is relatively linear, but as the spoke gets closer to the projection, the rate increase is much more rapid. During operation, the spoke is limited to movement in either direction, from its center position intermediate two projections 164, through an angle α (FIG. 7) of less the angle between the spoke and the next adjacent projection. In the illustrated embodiment, the spoke has a range of travel of less than ±45°, the projections being 90° apart.

Lower amplitude, higher frequency vibrations at or acting on the wheel 20, 120 and/or second member 32, 132 which may be caused by unsmooth surfaces, such as those illustrated by F₂ and F₃ (FIG. 7), are isolated from the frame 16 through the walls 90, 190 of the bushing 60, 160. Since there is no non-elastomeric transfer path, isolation is present at all frequencies, input amplitudes, and in all directions.

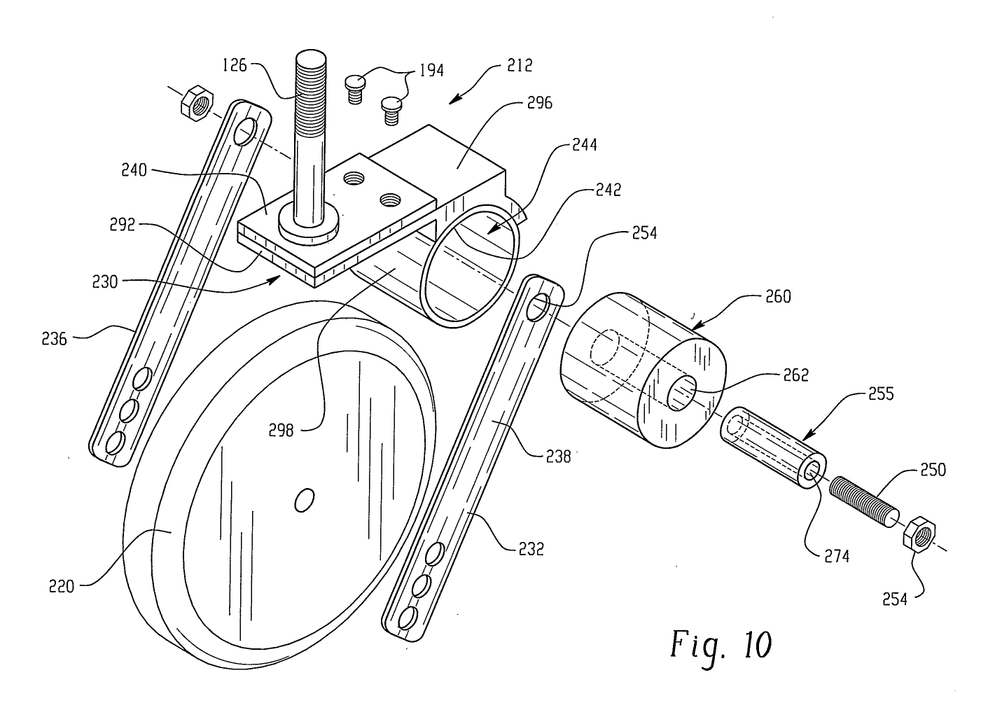

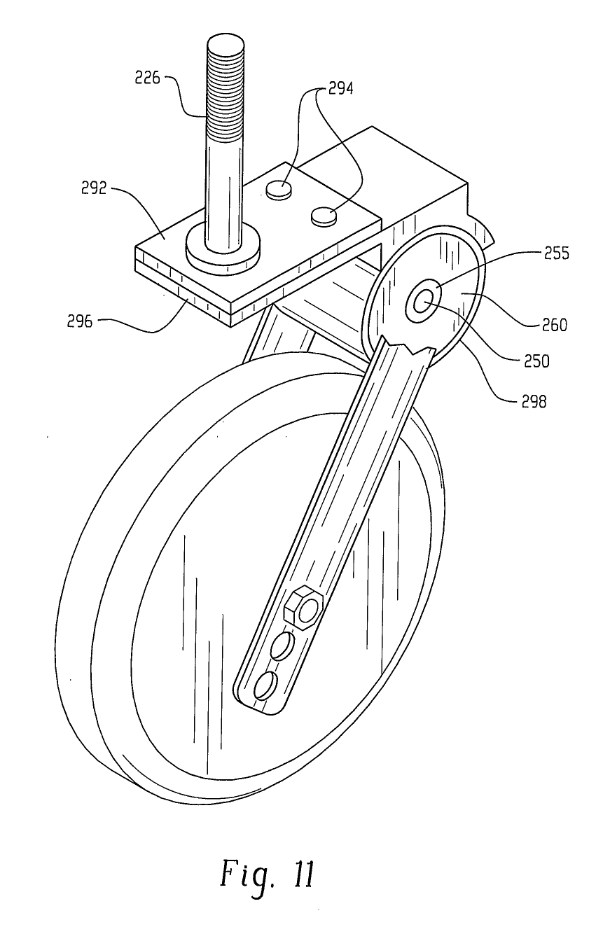

With reference now to FIGS. 10 and 11, an alternative embodiment of a suspension system 212 is shown. The suspension system 212 is similar to the suspension system 12, except as otherwise noted. Similar elements are accorded similar numerals, increased by 200. The suspension system 212 includes a first structural member 230, in the form of a mounting bracket, and a second structural member 232, which supports a front wheel 220. The second structural member is rotatable, relative to the first structural member. In the illustrated embodiment, the first structural member 230 is formed from separate components which are welded, clamped, or otherwise rigidly held together. Specifically, a plate 292, which supports a stembolt 226, is mounted by bolts 294 or other suitable fixing means to a second plate 296 which is welded or otherwise rigidly attached to a cylindrical member 231. The member 231 defines a cylindrical socket 242. Alternatively, the structural member 230 may be integrally formed as for member 30.

The wheel 220 is rotatably mounted between distal ends of arms 236, 238 of second structural member 232 for engaging a floor or other surface over which the wheelchair travels. In the illustrated embodiment, there is no intermediate connecting member analogous to member 58, although it is contemplated that the arms 236, 238 may be joined intermediate the wheel and apertures 254.

The cylindrical socket 242 has first and second open ends 244 (FIG. 10) through which a shaft 250 is received. The shaft is mounted through respective bores 254 at ends of the arms 236, 238 remote from the wheel 220 and locked in place by suitable threaded lock nuts 256 or other fixing members.

A unitary molded bushing 260 is mounted in the socket 242. The bushing 260 defines a bushing bore 262 which receives the shaft 250 of the second member 232 therethrough. The bushing 260 is configured to develop a resistance force as the second member 232 pivots relative to the first member 230 about the shaft 250. The bushing 260 is held in place within the socket 242 of the cylindrical member by compression forces (the bushing 260 being fitted tightly into the socket 242), which resist rotation of the bushing, relative to the cylindrical member. Alternatively or additionally, projections (not shown) on the cylindrical member 231 (or bushing) are received in complementary recesses (not shown) in the bushing (or cylindrical member) to resist relative movement of the bushing. The projections and recesses may be similarly configured to projections 64 and recesses 66.

An insert 255 may be received within the bushing bore 262 of the bushing 260 and is generally cylindrical in shape. The insert 255 defines an axially extending bore 274 shaped to receive the shaft 250 therethrough. The bore 274 may be configured to limit relative movement of the shaft 250 in a similar manner to that described for the embodiments of FIGS. 7 and 8. In the embodiment illustrated in FIG. 10, the bore 274 is eccentric, e.g., oval or elliptical in shape, and receives a complementary oval or elliptical portion of the shaft 250.

In another embodiment, the ovality or other eccentricity enables the bore to receive a mating feature on the fork or clevis 234 to allow for positive interlock, and thus eliminate the need to rely on fastener torque force and the friction of the slip-plane.

In another embodiment, the bore 274 is internally threaded to engage corresponding threads on the shaft 250.

In the embodiment of FIG. 10, the exterior spokes 80 of FIG. 2 are absent, although it is also contemplated that spokes similar to spokes 80 and corresponding bushing pockets may be provided.

As with the embodiment of FIGS. 2-9, all forces which are transmitted to the insert 255 from the shaft 250 are isolated from the first member 230 by the bushing 260 where they are thus at least partially absorbed by the complementary damping forces generated in the bushing.

When the front wheel 220 of the wheelchair encounters a large amplitude input, the rotational force on the shaft 250 is transferred from the shaft to the insert 255 in a similar manner to that described above. Complementary resistance forces develop in the bushing, which resist rotation. However, the travel restrictor function is lacking in this embodiment because the spokes (and optionally also the projections) serve are absent. The extent of vertical travel in the front wheel 220 is thus determined by the input amplitude (mm) of the force and the durometer (radial stiffness) of the bushing. As with the embodiment of FIGS. 2-5, lower amplitude, higher frequency vibrations of the wheel 220 and/or second member 232, which may be caused by unsmooth surfaces are isolated from the frame 16 through the walls 290 of the torsional bushing 260. Since there is no non-elastomeric transfer path, isolation is present at all frequencies, input amplitudes, and in all directions.

It will also be appreciated that while the suspension system 12, 112, 212 has been previously described with reference to the first member 30, 130, 230 as being pivotally connected to the wheelchair frame and defining a socket 42, 142, 242 which receives a resilient member 60,160, 260 therein, with the second member 32,132, 232 carrying a wheel 20, 120, 220 and being operably connected to the insert by a elongated connecting member, such as connecting members 50 or a shaft 150, 250, it is also contemplated that the positions of the tubular connecting member and resilient member may be reversed. Specifically, the second member 32, 132, 232 may define a socket, similar to socket 42, 142, 242, which receives a resilient member analogous to member 60, 160, 260 and the first member 30,130, 230 may be operably connected with the insert 55, 155, 255 by connecting members 50 or a shaft analogous to shaft 150, 250.

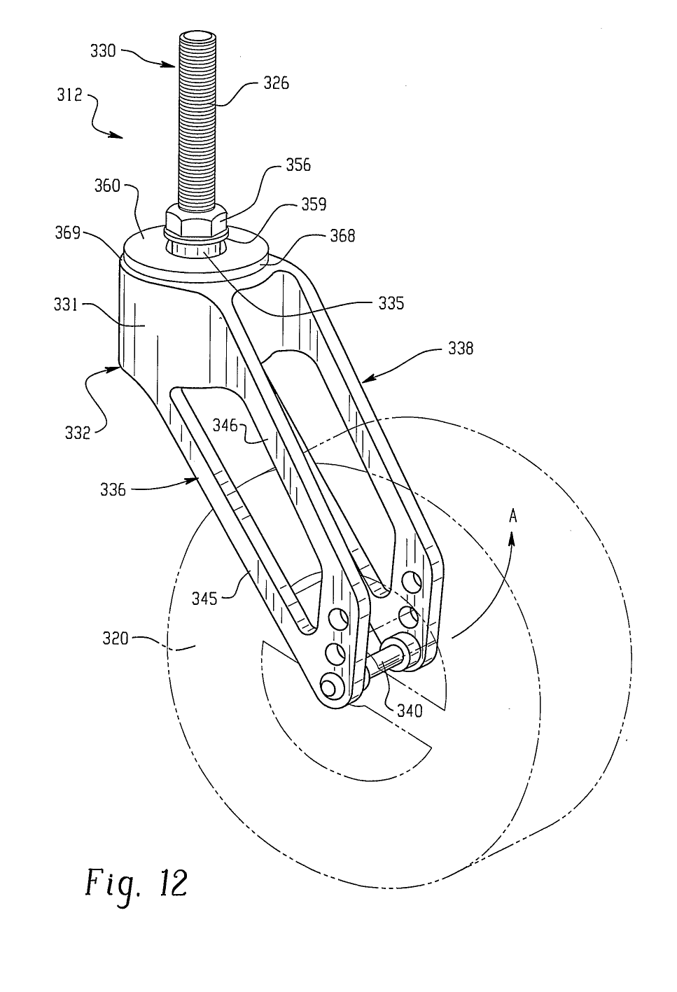

For example, as shown in FIGS. 12-14, an alternative embodiment of a suspension system 312 which reverses the positions of the socket and shaft is shown. The suspension system 312 is similar to the suspension system 12, except as otherwise noted. Similar elements are accorded similar numerals, increased by 300. The suspension system 312 includes a first structural member 330, in the form of a mounting bracket, and a second structural member 332, which supports a front wheel 320.

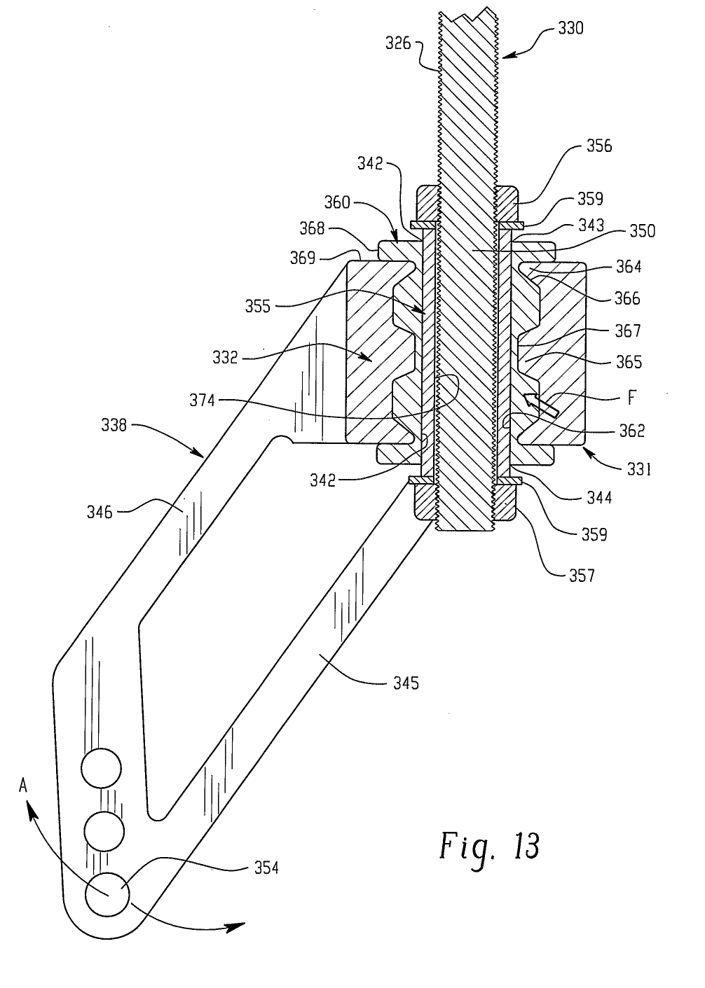

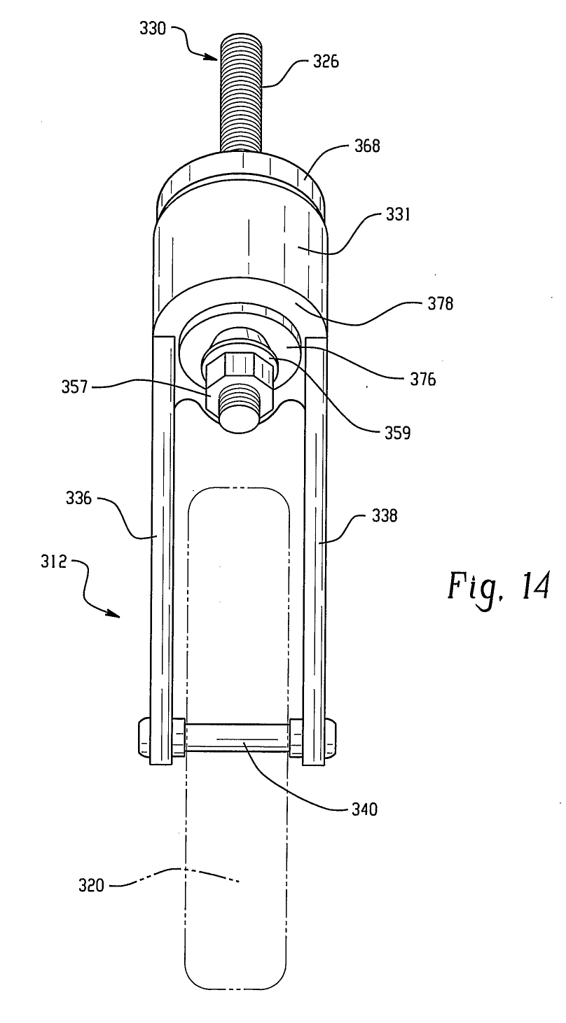

The second structural member 332 is rotatable, relative to the first structural member 330. In the illustrated embodiment, the mounting bracket 330 includes a stembolt 326. The second structural member 332 includes a cylindrical member 331. The cylindrical member 331 defines a cylindrical socket 342 (FIG. 13).

A wheel 320 is rotatably mounted between distal ends of arms 336, 338 of first structural member 332 for engaging a floor or other surface over which the wheelchair travels. Specifically, an axle 340, which carries the wheel 320 is rotatably mounted at ends thereof to the arms 336, 338 via apertures 354. In this embodiment, the arms each include two generally parallel members 345, 346 which are attached at their upper ends to the cylindrical member 331, forward and rearward of the socket 342, respectively. In the illustrated embodiment, there is no intermediate connecting member analogous to member 58, although it is contemplated that the arms 336, 338 may be joined intermediate the wheel apertures 354 and socket 342.

The cylindrical socket 342 has first and second open ends 343, 344 (FIG. 13) through which a shaft portion 350 of the stembolt 326 is received. The shaft 350 may be locked in place by suitable threaded lock nuts 356, 357 or other fixing members. Together, the shaft portion 350 and optional insert 355 serve as a rigid member that is operatively connected with the stembolt shaft 256. The shaft portion 350 and optional insert 355 are thus constrained against rotational and pivotal movement relative to the stembolt 256.

A unitary molded bushing 360 is mounted in the socket 342. In this embodiment, the bushing is generally vertically aligned (i.e., perpendicular to the ground), and may be axially aligned with the shaft 326, although it is also contemplated that the bushing may be angled to the vertical such at as an angle θ, which is from about 0° to about 45°. While the illustrated bushing 360, and the socket 342 in which it is received, are circular in cross section, it is also contemplated that the bushing and socket may have other cross sectional shapes, such as elliptical or polygonal, e.g., square or rectangular in shape. The bushing 360 defines a bushing bore 362 which receives the shaft 350 of the second member 330 therethrough. The bushing 360 is configured to develop a resistance force as the second member 232 pivots relative to the first member 330. The forces developed during pivoting tend to be conical forces. For example, when the wheel hits a large bump (a large amplitude input) and the support member 332 is rotated upwardly in the direction of arrow A this embodiment, the cylindrical member exerts a force F on the bushing, which in turn develops a resistive force in the opposite direction. The Force F is generally in the same direction as arrow A. As with other embodiments, the resistive force is small initially and quickly builds up, absorbing the impact while returning the wheel to its normal position. The bushing 360 reacts to smaller, amplitude purely vertical inputs with the bushing acting in shear, allowing for increased softness and isolation in that direction. Lateral rigidity and control are provided by the significantly stiffer axial-rate of the system, without compromising the isolation in the directions of most concern.

An advantage of this embodiment is that the vertical alignment of the bushing and its cylindrical receiving member allows a compact structure which is less likely to cause an obstruction than in other embodiments. Additionally, the cylindrical member may be integrally formed with the arms, resulting in cost savings for tooling and in assembly.

The bushing 360 may be held in place within the socket 342 of the cylindrical member 331 by compression forces (the bushing 360 being fitted tightly into the socket 342), which resist rotation of the bushing, relative to the cylindrical member and movement in a vertical direction. Alternatively or additionally, vertical retention may be provided by projections 364, 365 on an interior surface of the cylindrical member 331 (or bushing), which are received in complementary annular recesses 366, 367 in an exterior surface of the bushing (or cylindrical member) to resist relative movement of the bushing. The projections may be annular or arcuate. To allow for the conical forces which are most pronounced at upper and lower ends of the bushing, one of the projections and complementary recess 365, 367 may be located intermediate the upper end lower ends 343, 344, such as approximately midway therebetween. The illustrated embodiment also includes upper and lower projections 364, and corresponding recesses 366, which are located closer to the ends of the socket 342. Unlike the projections and recesses 64, 66, which extend the full length of the bushing, the projections 364, 365 may extend only part way down the bushing, as shown. In this way, the impact on the conical stiffness of the bushing is minimized. Alternatively, the bushing may be fitted with a retaining ring (not shown) which is received within the recess 367. The retaining ring is compressed into the recess during fitting of the bushing into the socket 342 and then expands into a complementary recess in the wall of the cylindrical member.

In some embodiments, vertical retention may be additionally or alternatively provided by mold bonding the bushing 360 to a rigid can (not shown) which is press fitted into the socket 342. In other embodiments, vertical retention may be additionally or alternatively provided by upper and lower retaining elements 356, 357, such as lock nuts, which are threadably mounted to the shaft 350. Elastomeric washers 359 may be provided to space the nuts from an insert 355 (FIG. 13).

In some embodiments, the bushing 360 includes a radially extending flange 368 at its upper end which extends over an upper surface 369 of the cylindrical member. The flange 368 helps to absorb purely vertical impacts. A similar flange 376 may be defined at a lower end of the bushing 360, which extends radially outward from the socket 342 to contact a lower surface 378 of the cylindrical member (FIG. 14). The lower flange is sufficiently flexible to deflect while inserting the bushing into the socket from the upper end of the socket.

The insert 355 is received within the bushing bore 362 of the bushing 360 and is generally cylindrical in shape. The insert defines an axially extending bore 374 which receives the shaft 350 at least partially therethrough. In the embodiment illustrated in FIG. 13, the bore 374 is internally threaded and engages complementary threads on the shaft 350. The insert may be compression fit into the bushing or physically attached to the bushing, for example, by mold bonding. The threading allows the second member to be readily removed from the first member. In alternative embodiments, the insert 355 is simply a portion of the shaft 350 which engages or is mold bonded to the bushing.

In the embodiment of FIG. 13, the exterior spokes 80 on the insert of FIG. 2 are absent. As with the embodiment of FIGS. 2-11, the bushing 360 isolates the second structural member 332 from the first structural member 330. In this embodiment, all forces which are transmitted to the bushing from the cylindrical member are isolated from the insert 355 and shaft 350 of the first member 330 by the bushing. The forces are thus at least partially absorbed by the complementary damping forces generated in the bushing.

When the front wheel 320 of the wheelchair encounters a large amplitude input, the rotational force on the cylindrical member 331 is transferred to the bushing 360. Complementary resistance forces develop in the bushing, which resist rotation. The extent of vertical travel in the front wheel 320 is thus determined by the input amplitude (mm) of the force and the durometer (stiffness) of the bushing 360. As with the embodiment of FIGS. 2-11, lower amplitude, higher frequency vibrations of the wheel 320 and/or second member 332, which may be caused by unsmooth surfaces are isolated from the frame 16 through the bushing 360. Since there is no non-elastomeric transfer path, isolation is present at all frequencies, input amplitudes, and in all directions.

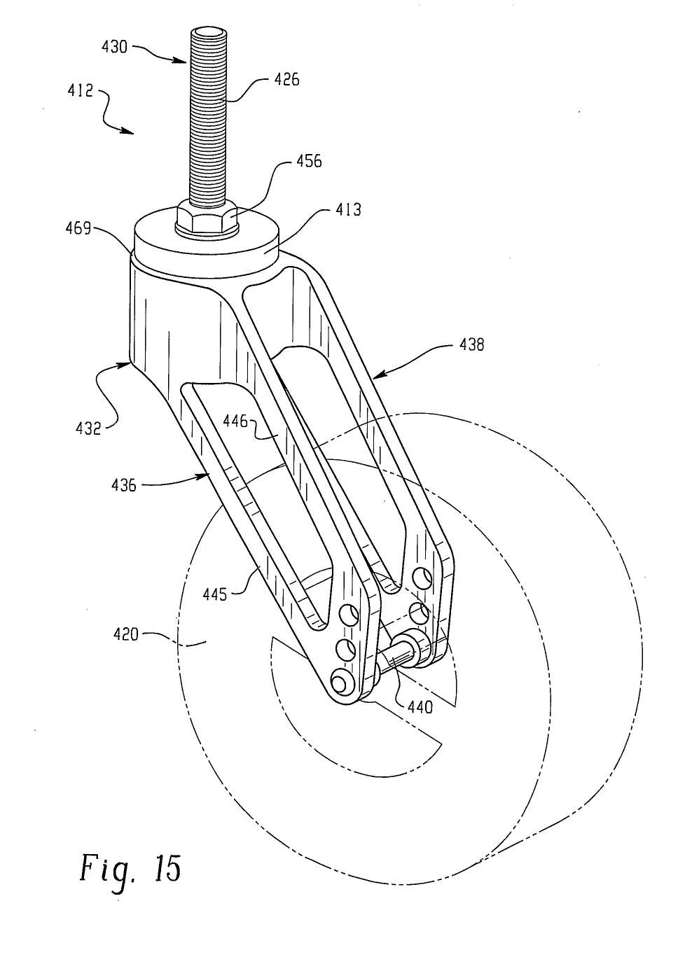

With reference to FIG. 15, a suspension system 412 is similar, except as noted, to the suspension system 312 of FIGS. 12-14, where similar elements have similar numbers, increased by 100. In this embodiment, an annular elastomeric element 413 having a stiffness which is lower than the stiffness of the bushing is located on top of the bushing. The elastomeric element 413 spaces the locknut 456 from the top of the cylindrical element. The elastomeric element 413 may take the place of the flange 368 of FIG. 13 or be placed on top of the flange.

While the suspension system 12, 112, 212, 312, 412 is described with reference to a wheelchair, it is to be appreciated that it finds application in other shock absorbing devices, such as bicycle seat suspensions, hand carts, and that the first and/or second member may be replaced with another suitable connection member. It is also contemplated that fewer than two or more than two suspension systems may be employed in a single transportation system.

1. A suspension system (12, 112, 212, 312, 412) comprising:
a first structural member (30, 130, 230, 330, 430);
a second structural member (32, 132, 232, 332, 432) pivotable relative to the first structural member, one of the first and second structural members including a socket (42, 142, 242, 342);
a rigid member (55, 150, 155, 255, 350, 355) mounted in the socket, the rigid member being connected with the other of the first and second structural members so as to resist movement relative thereto; and
a resilient member (60, 160, 260, 360) mounted in the socket, the resilient member defining a bore which receives the rigid member therein, the resilient member developing a resistance force as the second structural member pivots relative to the first structural member, the resistance force resisting further pivoting of the second structural member relative to the first structural member.

2. The suspension system of claim 1, wherein the resilient member isolates the first structural member from the second structural member such that there are no non-resilient vibration transfer paths between the first and second structural members.

3. The suspension system of claim 1, wherein the second structural member is angled to the first structural member.

4. The suspension system of claim 1, wherein the second structural member carries a wheel (20, 120, 220, 320, 420), the wheel being spaced from the resilient member.

5. The suspension system of claim 1, wherein the second structural member comprises first and second arms (36, 38, 136, 138, 236, 238, 336, 338).

6. The suspension system of claim 5, wherein the second structural member (32) further includes a connecting member (58), the support member connecting the first and second arms.

7. The suspension system of claim 1, wherein the first structural member (30, 130, 230, 330, 430) includes a connector (22) for pivotally connecting the suspension system to an associated frame member.

8. The suspension system of claim 1, wherein the second structural member (332, 432) includes the socket (342).

9. The suspension system of claim 8, wherein the resilient member (360) is aligned generally vertically.

10. The suspension system of claim 8, wherein a projection (364, 365) extends from one of the socket and the resilient member and is received in a recess (366, 367) of the other of the socket and the resilient member.

11. The suspension system of claim 8, wherein the rigid member comprises an insert (355) and the first structural member (330, 430) comprises a shaft (326, 426) which is threadably connected with the insert (355).

12. The suspension system of claim 8, wherein the first structural member (330, 430) comprises a shaft (336, 426) and the rigid member (350, 355) and resilient member (360) are axially aligned with the shaft.

13. The suspension system (412) of claim 8, further comprising an elastomeric member (413) of a lower durometer than the resilient member, the elastomeric member contacting the resilient member and absorbing generally vertical impacts on the wheel.

14. The suspension system of claim 1, wherein the first structural member comprises a shaft (326, 426) and the rigid member comprises an extension (350) of the shaft.

15. The suspension system of claim 14, wherein the rigid member further comprises an insert (355), the insert being received on the shaft extension (350).

16. The suspension system of claim 1, wherein the rigid member (150, 155, 250, 255, 350, 355) comprises a shaft (150, 250, 350) and an insert (155, 255, 355) mounted on the shaft, the insert being constrained by the shaft against movement relative to the other of the first and second structural members.

17. The suspension system of claim 1, wherein the socket (42, 142, 242, 342) defines at least one projection (64, 364, 365) which extends into the resilient member, the projection being spaced from the insert by the resilient member.

18. The suspension system of claim 1, wherein the resilient member comprises an elastomer.

19. The suspension system of claim 1, wherein the socket (42, 142, 242, 342) is generally cylindrical.

20. The suspension system of claim 1, wherein the insert is shaped to constrain the second structural member against rotational movement relative to the insert.

21. The suspension system of claim 1, wherein the rigid member includes an insert (55, 155), the insert defining a generally annular inner portion and at least one spoke (80, 180) which extends from the inner portion into the resilient member.

22. The suspension system of claim 21, wherein the socket defines at least one projection (64, 164) radially spaced from the at least one spoke (80, 180) which extends into the resilient member (60, 160), the spoke and the projection being spaced by the resilient member.

23. The suspension system of claim 22, wherein the at least one spoke (80, 180) includes at least three spokes and the at least one projection (64, 164) includes at least three projections.

24. The suspension system of claim 1, wherein the force is a radial force.

25. A wheelchair (10) comprising the suspension system of claim 1.

26. A suspension system (12, 112, 212, 312, 412) comprising:
a first structural member (30, 130, 230, 330, 430);
a second structural member (32, 132, 232, 332, 432) which carries a wheel (20, 120, 220, 320, 420), the second structural member being pivotable relative to the first structural member;
a resilient member (60, 160, 260, 360) which isolates the second structural member from the first structural member such all vibration transfer paths between the first and second members pass through the resilient member.

27. The suspension system of claim 26, further comprising:
an insert intermediate the resilient member and the first structural member.

28. A transportation system comprising:
a frame (16);
a wheel (20, 120, 220, 320, 420) for conveying the transportation system across a surface;
a suspension system (12, 112, 212, 312, 412) comprising:
a first structural member (30, 130, 230, 330, 430) which is pivotally connected to the frame,
a second structural member (32, 132, 232, 332, 432) which carries the wheel,
a rigid member (55, 150, 155, 250, 255, 350, 355) operably connected with the other of the first and second structural members, and
a resilient member (60, 160, 260, 360) mounted in a socket (42, 142, 242, 342) defined by one of the first and second members, the resilient member defining a bore (62, 162, 262, 362) which receives the rigid member therein, the resilient member isolating the second structural member from the first structural member.

29. The transportation system of claim 28, wherein the transportation system is a wheelchair and wherein the frame supports a seat (18).

30. The transportation system of claim 28, wherein the first member (330, 430) comprises a shaft (326, 426) and wherein the rigid member (350) comprises an extension of the shaft.

31. A method of absorbing shocks in a suspension system comprising:
pivoting a second structural member (32, 132, 232, 332, 432) relative to a first structural member (30, 130, 230, 330, 430), the first and second members being spaced by a resilient member (60, 160, 260, 360) which isolates the first member from the second member, the resilient member developing a resistance force as the second member pivots relative to the first member the resistance force resisting further pivoting of the second member relative to the first member.
